(19) United States
(12) Patent Application Publication
(10) Pub. No.: US 2007/0106591 A1
(43) Pub. Date: May 10, 2007

(54) Method and instrument for financing backed by collateralized debt obligation-type structures

(76) Inventor: Benjamin Waisbren, Whitefish Bay, WI (US)

Correspondence Address: Ward & Olivo, Suite 400, 382 Springfield Avenue, Summit, NJ, 07901, US

(21) Appl. No.: 11/450,734

(22) Filed: Jun. 9, 2006

Related U.S. Application Data
(60) Provisional application No. 60/734,481, filed on Nov. 8, 2005.

(51) Int. Cl. G06Q 40/00

(52) U.S. Cl. 705/36 R

(57) ABSTRACT

Disclosed is a method for financing assets. The method entails executing a CDO-type structure and a related financing agreement associated with the financed assets, preferably high-risk assets (such as motion picture production loans) and which have highly volatile returns. In one embodiment, the co-financing arrangement between an equity investor and a third party and an interest in CDO equity are used together to secure loans made by a lender to finance the equity investor's obligations under the co-financing arrangement. The equity investor assigns the proceeds from the co-financing agreement to the lender and guarantees that the total return from the CDO collateral and the co-financed collateral does not fall below a predetermined threshold in exchange for CDO proceeds derived from CDO investments and co-financed collateral.

### CROSS-REFRENCE TO RELATED APPLCIATIONS

This application claims priority to U.S. Provisional Application Ser. No. 60/734,481, filed Nov. 8, 2005, the entire contents of which are herein incorporated by reference.

### FIELD OF THE INVENTION

The present invention generally relates to the financing of assets, and particularly the financing of assets requiring external collateralization, especially assets that are highly risky and/or have highly volatile returns.

### BACKGROUND OF THE INVENTION

Portfolio Risk Management Generally

Individuals, enterprises, and corporations are continually exposed to the risk of future events beyond their control, which can either positively or negatively impact their financial stability. Certain risk is economic in nature, including fluctuation of commodity prices, currency exchange rates, interest rates, property prices, share prices, inflation rates, and market event based indices. Economic risk can take many forms, from price risk (i.e., the risk of fluctuating prices) to credit risk (i.e., the risk of default). These risks are generally the primary concern of financial markets.

Financial markets measure risk in terms of volatility. Volatility is a statistical measure of the tendency of the value of a market, security, derivative or other asset to rise or fall sharply within a given period of time. If the tendency is for a security to rise or fall very sharply during a relatively short period of time, the security is said to be highly volatile. Additionally, if an asset rises or falls sharply relative to a similar asset, such asset is also said to be highly volatile. Therefore, volatility can be described in two manners: (1) historical volatility, which is the volatility of an asset relative to its historical price, and (2) relative volatility, which is an asset's volatility relative to a benchmark index or other financial asset.

From an investment perspective, historical and relative volatility are considered risks that investors generally attempt to avoid. In other words, if two assets offer the same potential return, an investor would prefer to purchase the less volatile (i.e., less risky) asset. In such situations, an investor will generally take on increased risk only if the investment could result in potentially higher returns.

Modern investment portfolio theory utilizes these behavioral characteristics as a fundamental assumption in determining the ideal combination of investment holdings. An investor's total financial holdings are known as a portfolio. In essence, modern portfolio theory holds that a diversified portfolio (i.e., one that contains financial holdings that do not have a high degree of positive correlation with one another) reduces volatility and thereby optimizes the risk-return profile of a portfolio. That is, an investor receives maximum potential returns at a given level of risk. The risks of different assets are said to be “positively correlated” when the price movements, or risk of loss, with respect to such assets are related; assets are “highly correlated” when such price movements are likely to be consistent in time and magnitude.

The High Volatility of Certain Specialty Finance and Other Businesses

The financing of certain businesses and assets involve significant risk and volatility that are difficult to mitigate or diversify in a manner similar to those techniques used to manage the volatility of CDO transactions. These types of financings are well known, for example, in the motion picture industry, where the repayment of investments made to finance the production of a motion picture is collateralized by an asset without a readily ascertainable cash value (i.e., a motion picture) because whether a movie will be a financial success is largely unknown. Returns to the financier of motion picture production are highly volatile because the financier's returns are subject to, among other things, (i) the vagaries of box office receipts (driven by the unpredictable and rapidly-changing tastes of the viewing public and other factors), (ii) the risk that motion pictures will not be completed on budget and on time due to cost overruns or other unforeseen events, (iii) in the case of independently-produced pictures the willingness of studios and independent distributors to distribute the picture at an opportune time and in a sufficient number of theaters and (iv) the evolving nature in which motion pictures are distributed as a result of rapidly-changing technology.

As a result of these risks, lenders generally are unwilling to lend money to finance motion picture production costs without significant cash or other collateral being posted (in addition to the assets relating to the motion picture itself), or substantial financial commitments from motion picture distributors (which may or may not be obtained). In addition, whether or not a portion of the production costs are borrowed, a motion picture financier's returns are likely to be highly volatile, even if it spreads its risk over a number of motion pictures.

Other specialty finance investments, such as certain investments in equipment leasing and receivables factoring, and certain other lending arrangements, can involve similar risk profiles. Another suitable financial asset could be the development (including pre-clinical and/or clinical testing) of pharmaceutical drug candidates, including biotech drugs. The high volatility of these businesses often makes it difficult for such businesses to attract debt and equity capital, or to induce lenders to finance their operations. Because of the high volatility of such businesses, there is a clear need in the art for a financing arrangement that capitalizes on the potentially high returns of these types of specialty finance investments while avoiding the high volatility.

Collateralized Debt Obligations (CDOs)

We have briefly described below a product known as a collateralized debt obligation (“CDO”). Depending upon the assets acquired, CDOs are sometimes variously referred to as collateralized loan obligations or collateralized bond obligations, but we use the generic term “CDO” herein. As described below, certain contractual and other arrangements can replicate the economic effect of CDOs. We refer to CDOs and those contractual and other arrangements that replicate the economic effects of CDOs collectively herein as “CDO-type structures.”

Generally speaking, a CDO involves a special-purpose domestic or foreign company (which we call the “issuer”) which acquires a portfolio of bonds or loans at the direction of an investment advisor or collateral manager. In a traditional “cash CDO,” the acquisition of the portfolio is financed by (1) the issuance of (i) equity securities and (ii) various classes of fixed-income debt securities (which frequently are rated by one or more nationally-recognized rating agencies) and (2) in some instances, a term or revolving credit facility. These various tranches of debt securities (and, if applicable, the credit facility) are then repaid from the cashflows received on the portfolio, with any cashflows remaining after the debt is repaid being distributed to holders of the equity securities.

Each individual class of debt securities issued by an issuer is known as a “tranche.” Each tranche offers various maturity and credit risk characteristics (reflected by, among other things, their respective priority of repayment). Tranches are categorized as senior, mezzanine, and subordinated according to the respective amount of credit risk. Subordinated and mezzanine tranches generally bear higher interest rates than more senior tranches. In the event that the cashflows received by the issuer on the portfolio of bonds and loans are insufficient to make scheduled payments of interest and principal on the debt securities issued by the CDO entity to senior tranches, senior tranches take priority over those of mezzanine tranches, and scheduled payments to mezzanine tranches take priority over those to subordinated tranches. These multiple tranches allow varying levels of credit exposure to the underlying portfolio to be transferred to investors that are willing to take varying levels of risk.

Returns to equity investors depends largely upon the difference or “spread” between the weighted average interest rates of the underlying bonds and loans and the weighted average of the debt capitalization issued by the CDO issuer. This spread is significant in magnitude because the more senior tranches of debt capital issued by CDOs are frequently highly rated and thus carry relatively low interest rates. Most CDOs are structured around the arbitrage opportunity created by the spread.

CDOs generally are very highly “leveraged,” meaning that the amount of debt is very large in relation to the equity capitalization. The high leverage of CDOs translates into potentially very high returns (or very significant losses, in the event of higher-than-expected defaults on the underlying loans or securities) to the holders of the equity securities. To take an example, assume that the total capitalization of a CDO is $500 million, of which the equity capital comprises $50 million, or 10%. The entire $500 million is applied to acquire bonds and loans in the market. The equity investor stands to lose its entire investment if only 10% of the underlying bonds or loans were to default. On the other hand, in exchange for its $50 million investment, the equity investor receives the interest cashflow on the full $500 million of bonds and loans, less the portion of this amount needed to service the debt capital.

Managing the Volatility: “Market Value” vs. “Cashflow” CDOs

CDO transactions must be carefully structured and managed in order to mitigate the potentially high volatility of returns. This risk mitigation is necessary in order to, among other things, obtain ratings of the debt securities from nationally-recognized rating agencies. There are two general types of CDO structures, reflecting two approaches to risk mitigation: market value CDOs and cashflow CDOs, each of which is described below.

In a market value CDO the underlying portfolio of bonds or loans is valued periodically. In the event that the market value is less than a specified percentage of the outstanding balance of the debt capital, a portion of the bonds or loans is liquidated and the proceeds are used to pay down the debt capital (or take other action to increase the value of the loans or securities relative to the balance of the debt capital). As a result, the risk to holders of the debt capital is reduced because they are highly likely to receive payments as long as the CDO contains collateral which can be liquidated. The market value CDO structure, in conjunction with other optional features (including, for example, minimum diversity requirements that are related to the underlying obligations held by the CDO) is designed to minimize the volatility of returns realized by both the debt and equity participants in CDOs.

A “cashflow” CDO, on the other hand, generally does not (with a few minor exceptions) contain triggering events relating to the market value of the portfolio. Instead, the issuer generally will be required to liquidate a portion of the underlying bonds and loans to repay debt capital only if either (i) the total principal amount of the bonds and loans is less than a specified percentage of the issuer's debt (known as “over collateralization coverage” or “principal coverage”) or (ii) the total amount of the interest cashflows received on the bonds and loans is less than a specified percentage of the amounts required to service the issuer's debt (known as “interest coverage”).

Both market value and cashflow CDOs typically also contain concentration limitations, asset eligibility criteria and “quality tests” which limit exposure to, among other things, (i) a particular industry (industry concentration limits), (ii) a particular company (issuer/obligor concentration limits), (iii) securities with average risk ratings below a certain level (minimum weighted average rating tests), (iv) assets generating too low a level of income (weighted average coupon tests) and (v) asset maturities extending beyond the maturity dates of the debt capital (thus creating market risk when the assets need to be sold to pay off the debt capital). Violation of these tests can result in the CDO manager's inability to trade the underlying bonds and loans, thus limiting the risk that mismanagement of the portfolio could give rise to non-payment of the debt capital. Thus, CDOs by their terms contain structural “rules” that take advantage of the principles of diversification described earlier in this section.

Synthetic CDOs

As an alternative to actually acquiring bonds and loans, an issuer may enter into one or more contractual arrangements—known as a “credit derivatives”—with a financial institution or another party, under which the issuer becomes exposed to the credit risk associated with one or more “reference obligations,” consisting of bonds or loans. The reference obligations are actual bonds or loans that are referenced in the credit derivative, but which neither party is actually obligated to acquire (although the counterparty frequently does actually own the reference obligations in order to limit its risk exposure). The most common varieties of credit derivatives are credit default swaps and total return swaps.

Under a “credit default swap,” if the reference obligation. experiences losses (as a result of defaults on the related bond or loan), the issuer is required to make payments to its counterparty on the credit derivative; in exchange for taking this credit exposure and risk, the counterparty pays the issuer a fixed “premium.” Under a “total return swap,” the counterparty simply pays the issuer an amount equal to all amounts that are actually paid on the reference obligation; in exchange, the issuer either makes an up-front payment equal to the value of the reference obligation, or pays the counterparty for market losses on the reference obligation. Thus, speaking very generally, credit derivatives put the investor in an economic position that is similar to direct ownership of the underlying reference obligations.

CDOs that primarily involve entering into credit derivatives, rather than the direct acquisition of bonds and loans, are known as “synthetic CDOs.” In synthetic CDOs, funds that the issuer raises from equity and debt investors are deposited into a collateral account that secures the issuer's obligations under the credit derivatives entered into by the issuer.

Credit Derivatives that Replicate the Economics of CDOs

A further “synthetic” alternative involves dispensing with the separate issuer and the issuance of securities altogether. The economics, from the perspective of an investor in equity securities issued by a CDO (including the “leverage” effect), can be replicated by means of a single contract—specifically, a “portfolio credit derivative” contract between an investor and a financial institution or other counterparty. The portfolio credit derivative would involve a portfolio of reference obligations, and could take the form of a credit default swap or a total return swap. If so provided, the bond and loans comprising the reference portfolio may be substituted from time to time, subject to agreed-upon limitations, at the direction of the issuer. We refer to these types of contracts, together with the cash and synthetic CDO structures described above (and any other structures with similar economic characteristics that may arise in the future), as “CDO-type structures.”

The equity investor generally posts cash collateral, or makes an initial payment, to the counterparty equal to all of, or some fraction of, the initial value of the reference portfolio. The parties then make payments under the portfolio credit derivative with the effect that the investor bears the credit risk on the reference portfolio in exchange for a return that generally bears a relationship to the returns associated with ownership of the reference portfolio.

Portfolio credit derivatives also may be “leveraged” to varying degrees. A lower initial payment by the investor to the counterparty translates into higher “leverage” and more volatility from the investor's perspective. The counterparty's economic position, on the other hand, is similar to that of the senior debt investor in a “cash” CDO structure because, in exchange for lower risk and a predetermined interest rate, it is giving to the equity investor the upside return and upside risk tied to the portfolio of loans.

Under a “portfolio total return swap,” for example, the reference portfolio is valued and accounted for periodically and (i) the counterparty is obligated to pay to the equity investor an amount equal to all interest and other amounts paid out on the bonds or loans comprising the reference portfolio, plus any increase, from time to time, in the total market value of the reference portfolio and (ii) the equity investor is obligated to pay to the counterparty (x) any losses on the reference portfolio and (y) an amount equal to interest on the amount that is hypothetically “borrowed” from the counterparty to acquire the reference portfolio (usually the difference between the total principal amount of the reference portfolio and the initial payment made by the equity investor to the counterparty).

### SUMMARY OF THE INVENTION

The present invention overcomes the problem described above with respect to the financing of, or investment in, assets involving a high degree of risk and volatility by incorporating a CDO-type structure into such a financing or investment. In a preferred implementation of the invention, the bonds and loans underlying the CDO-type structure would be selected in a manner so that they bear a relatively uncorrelated risk to the financed assets, thereby combining two relatively uncorrelated risks to create a “blended” total product that offers an improved risk-return profile which is more palatable to investors.

The present invention discloses a novel method of utilizing the equity interests in a CDO-type structure in conjunction with a financing arrangement which is backed by high-risk assets (such as motion picture production loans) and which have highly volatile returns. We refer to these high-risk assets herein as the “financed assets.” In the preferred implementation of the invention, the bonds and loans subject to the CDO or the reference portfolio in the case of a portfolio credit derivative would be selected in a manner so that they bear a relatively uncorrelated risk to the financed assets. This is advantageous over prior art practices because the invention allows for the combination of these two types of assets which decreases the overall risk profile of such investments; thus, creating value by increasing the overall risk adjusted return.

In one embodiment, the method entails executing (i) a CDO transaction with one or more senior creditors and an equity investor and (ii) a financing arrangement involving high-risk financed assets with a lender and that same equity investor. Under prior art, the investor would have been required to post substantial collateral, consisting of cash or other assets with a readily ascertainable market value, in order to induce the lender to lend against the high-risk and undiversified financed assets. The lender, in turn, would have invested the cash collateral, on behalf of the investor, in “cash equivalents” (such as short-term U.S. government securities) or other assets with very little risk, which assets would yield a relatively very low return. Thus, the equity investor would be forced to allocate substantial capital to investments that would produce a very low return (or, alternatively, would have needed to forego the loan entirely and acquire the financed assets with its own funds).

Under one embodiment of the present invention, the equity investor pledges its equity interest in the CDO, in lieu of cash, as additional collateral for the financing arrangement. The lender is comfortable making its loan because the risk of loss on the high-risk assets and the CDO are relatively uncorrelated with one another, meaning that it is unlikely that both the high-risk financed assets, and the bonds and loans subject to the CDO, would default simultaneously. The equity investor enjoys the leveraged returns provided by the CLO equity investment, which are substantially higher than the yield it would have received on any “cash equivalents” in which posted cash collateral would have been invested.

In an alternate embodiment, the CDO portion of this method can be replaced with a portfolio credit derivative as described above. In this embodiment, any cash collateral that the equity investor is required to post under the portfolio credit derivative is also posted to secure the loan. In addition, in the case of a portfolio total return swap, the equity investor pledges its interest in the total return swap as collateral for the loan. Both the lender and the total return swap counterparty are comfortable sharing the collateral because the risks relating to the financed assets, and the reference pool under the total return swap, are relatively uncorrelated. Note that this structure (and its legal documentation) can be further simplified if the lender and the total return swap counterparty are the same person.

Of course, despite the structural safeguards described above, the credit quality (and, thus, the market value) of the underlying portfolio of bonds or loans relating to the CDO or portfolio credit derivative can deteriorate over time. Under some embodiments of the invention, the lender is induced to take this risk based on the equity investor's agreement to (i) in the case of a cash or synthetic CDO, make additional equity contributions to the CDO issuer or (ii) in the case of a portfolio credit derivative, post additional collateral, in each case in the amount of any losses relating to the CDO. We refer to these additional equity contributions or additional collateral herein as “top-up payments.” The equity investor also may be required to make additional top-up payments to compensate for deteriorations in the market value of the financed assets. As a result of these top-up payments, the lender is only exposed to the risk of day-to-day fluctuations in market value. Furthermore, due to the relatively uncorrelated nature of the risks relating to the CDO and the financed assets, it is unlikely that these risks will coincide. Failure by the equity investor to make a top-up payment, under most embodiments of the invention, would allow the lender to declare a default and liquidate the collateral. The obligation to make top-up payments work best in the context of a market value (as distinct from a cashflow) type CDO, because a market value CDO is already designed structurally to facilitate mark-to-market valuation of the underlying assets.

The use of equity interests in CDOs (or synthetic instrument having the economic characteristics of CDOs), to collateralize other financings is a novel concept and is particularly useful in financings, which involve high risk and volatility of returns. Any type of high-risk financing arrangements requiring external collateralization can utilize the present invention.

An object of the present invention is to provide a financing arrangement with a CDO structure and a related financing agreement.

Another object of the present invention is to create an improved method of financing high-risk assets with volatile returns.

Still another object of the present invention is the creation of an improved method for financing one or more motion pictures.

It is another object of the present invention to create a financing method with an improved risk adjusted return.

### BRIEF DESCRIPTION OF THE DRAWINGS

A further understanding of the present invention can be obtained by reference to a preferred embodiment set forth in the illustrations of the accompanying drawings. Although the illustrated embodiment is merely exemplary of systems for carrying out the present invention, both the organization and method of operation of the invention, in general, together with further objectives and advantages thereof, may be more easily understood by reference to the drawings and the following description. The drawings are not intended to limit the scope of this invention, which is set forth with particularity in the claims as appended or as subsequently amended, but merely to clarify and exemplify the invention.

FIG. 1A is a flow chart generally depicting a CDO structure utilized in accordance with the present invention;

FIG. 1B is a flow chart depicting a related financing arrangement in accordance with the present invention;

FIG. 2 is a flow chart depicting the associated financing in accordance with the present invention;

FIG. 3 depicts the non-correlation of asset classes which are utilized in accordance with the present invention;

FIG. 4 depicts the use of the non-correlated asset classes to increase total returns in accordance with the present invention;

FIG. 5 is a graph depicting the mitigating effect of a financing structure in accordance with the present invention on the volatility of the returns associated with a specialty finance portfolio; and

FIG. 6 is a flow chart describing an alternative embodiment of the invention utilizing a total return swap.

### DETAILED DESCRIPTION OF THE PREFRRED EMBODIMENT

A detailed illustrative embodiment of the present invention is disclosed herein. However, techniques, systems and operating structures in accordance with the present invention may be embodied in a wide variety of forms and modes, some of which may be quite different from those in the disclosed embodiment. Consequently, the specific structural and functional details disclosed herein are merely representative, yet in that regard, they are deemed to afford the best embodiment for purposes of disclosure and to provide a basis for the claims herein which define the scope of the present invention.

Moreover, well known methods and procedures for both carrying out the objectives of the present invention and illustrating the preferred embodiment are incorporated herein but have not been described in detail as not to unnecessarily obscure novel aspects of the present invention.

The use of the terms “lender,” “equity investor” and “investor” are not meant to limit the scope of the invention to one type of entity, as any entity or individual can utilize the present invention. References to parties, including “equity investor,” “lender” and “investor” in the singular or plural are not deemed exclusive, and in each case may include one or more persons or entities acting in such respective capacities. It will be understood based on the disclosure herein that in an alternate embodiment of the invention, a “portfolio credit derivative” (including a subset of a portfolio credit derivative, consisting of a “portfolio total return swap”) may be used interchangeably for the CDO. Finally, while a preferred embodiment describes a co-financing agreement with respect to a motion picture financing, it should be appreciated that any type of equity or debt financing arrangement that requires external collateralization can be utilized in accordance with the present invention. The following presents a detailed description of a preferred embodiment of the present invention.

Structure of the CDO Transaction and Related Arrangements

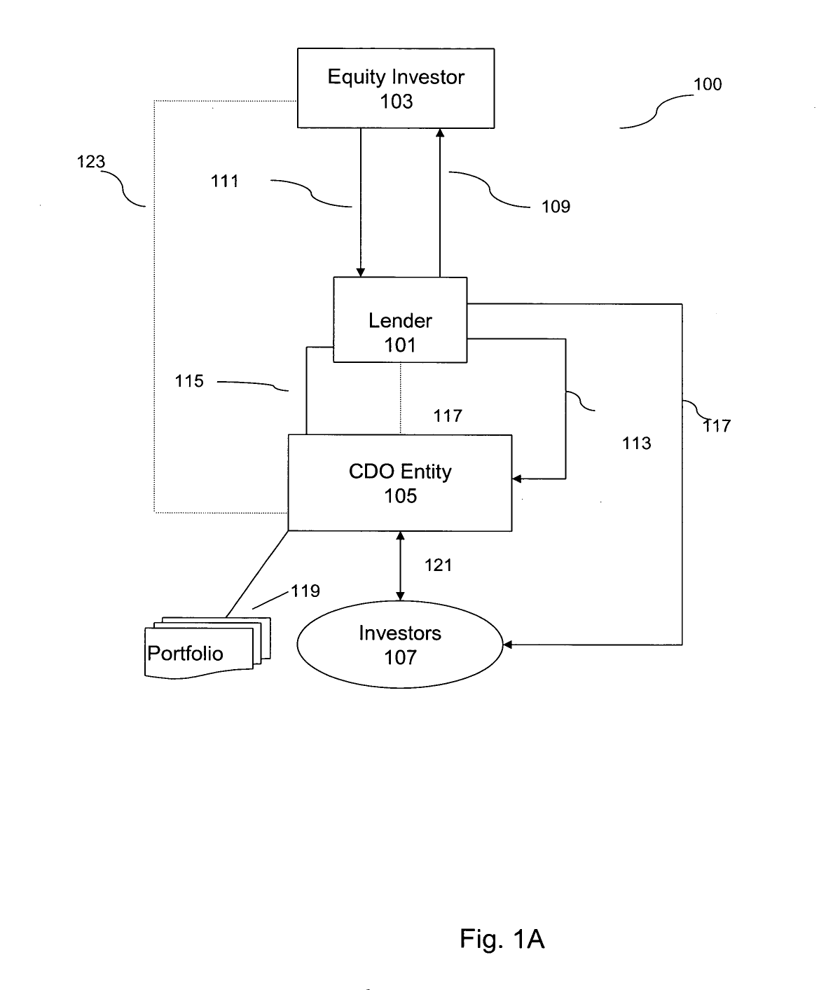

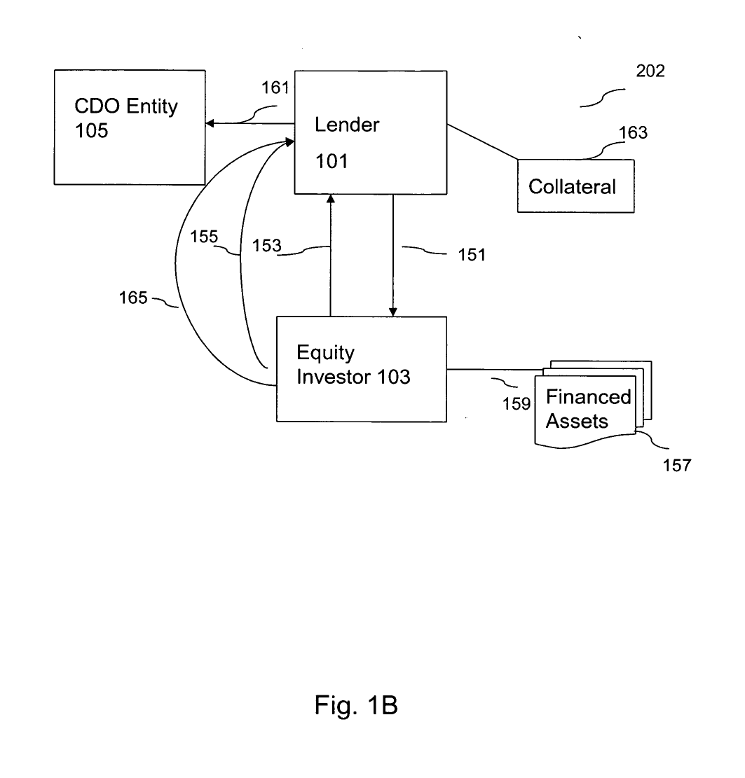

Referring to FIG. 1A, depicted is the general structure of a CDO transaction, as it could be utilized in accordance with one embodiment of the present invention, and the relationship among the equity investor, the lender and the CDO entity in the preferred embodiment of the invention. Lender 101 and equity investor 103 enter into a participation arrangement (which could be documented as a swap or other derivative transaction, or as a participation agreement) 100 on the effective date of the financing arrangement, under which lender 101 is the payer of certain amounts as depicted by 109. Lender 101 and equity investor 103 can each be one or more individuals, corporations, institutional investors, investment banks, or any other party or parties.

Under the terms of the participation arrangement 100, equity investor 103 makes an initial up-front payment 111 to lender 101 on the effective date in the amount of the purchase price paid to be paid by lender 101 for the equity issued by CDO entity 105. Lender 101 or a third-party investment bank or other party structures and arranges for a CDO transaction. In the preferred embodiment, the CDO structure is a market value CDO. Any entity can be appointed as the collateral manager of CDO entity 105; however, in the preferred embodiment of the present invention equity investor 103 or an affiliate thereof is appointed as the collateral manager. Under an alternative embodiment of the invention, the equity investor 103 simply purchases the equity directly from the CDO entity and pledges it to the lender 101.

In the preferred embodiment of the present invention, the material capitalization structure of CDO entity 105 consists of equity capital and debt capital. The debt capital can be in the form of term loans, revolving loans provided by lender 101 or another party, one or more tranches of rated debt securities sold in private placements or capital markets transactions, and any combination of the aforementioned. The equity capital can be in the form of preference shares or subordinated debt having the economic characteristics of equity. However, it is contemplated that any other capitalization structure can be used in accordance with the preferred embodiment of the present invention.

Lender 101 initially subscribes for all of the economic equity of the CDO entity 105 as depicted by 113 and becomes the owner of the economic equity of the CDO (as depicted by the dashed line 117). The economic equity can consist of preference shares, subordinated notes, a combination of the two, or any other structure as is known in the art. CDO entity 105 issues the equity to lender 101 as depicted by 115.

Lender 101, or a third party, acting as an underwriter, then acquires all of the debt capital of the CDO entity 105 and offers the debt capital for sale 121 to third party Investors 107 (or alternatively, arranges for a sale of the debt capital directly to third party Investors) in a manner known in the art to form a capitalization structure. The Investors 107 can be individuals, corporations, institutional investors, investment banks, or any other party (including the lender 101 or a third-party underwriter or placement agent).

CDO entity 105 utilizes the proceeds from the issuance of equity to lender 101 as shown by 115, and the sale of the debt capital 121, to acquire a diversified asset portfolio of bonds and loans 119. In the preferred embodiment of the present invention, the assets are syndicated loans of various borrowers (i.e., collateral loans). In accordance with the preferred embodiment of the present invention, the asset portfolio 119 is purchased at the direction of the collateral manager, subject to any additional terms of a management agreement or the relevant transaction documents. Although the asset portfolio preferably comprises a diversified portfolio of assets, as the term is used herein, the “asset portfolio” may comprise one or more of such assets.

As shown by 109, payments are made from lender 101 to equity investor 103 pursuant to the participation arrangement in an amount equal to the sum of (1) all dividends and other distributions, or, if applicable, interest and principal, received on the equity issued by the CDO entity (collectively, such dividends, interest, principal and other distributions referred to herein as “distributions”), and (2) all amounts received by lender 101 with respect to the related financing arrangement 200 as described below. In one embodiment of the present invention, these payments are made on a net basis against certain amounts that are payable by the equity investor 103 to the lender 101, as described below. In the alternative embodiment of the invention where the equity investor 103 acquires the CDO equity directly and pledges it to the lender 101, distributions on the CDO equity are paid (as shown by dotted arrow 123) to the equity investor 103 unless there is a default by the equity investor 103 on its arrangements with the lender 101 (whereupon the lender 101 may foreclose on the CDO equity and apply the proceeds to repay the equity investor's 103 obligations to the lender 101).

The Related Financing Arrangement

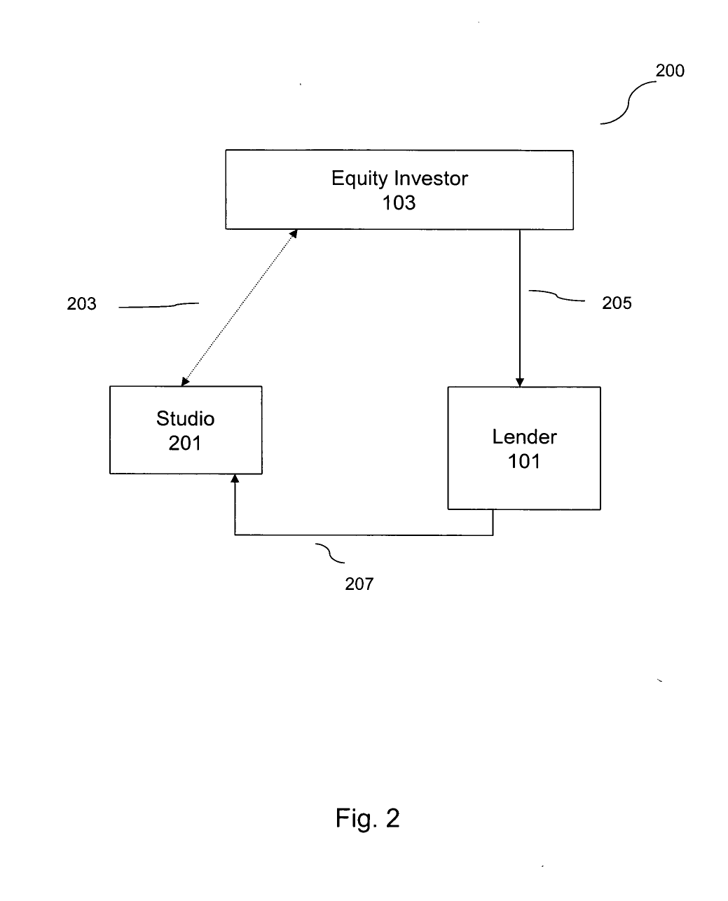

As shown in FIG. 1B, and in accordance with a preferred embodiment of the present invention, lender 101 makes a single up-front advance, or multiple periodic advances, under the related financing arrangement 202, to finance the acquisition 159 of the financed assets 157 (such assets are preferably high-risk, such as motion pictures, an example of which is described in further detail in the discussion of FIG. 2, below). These advances are payable by lender 101 to equity investor 103 or alternatively to third parties (not shown) on behalf of equity investor 103. Equity investor 103 makes payments 153 to the lender 101 representing interest to compensate the lender 101 for making these advances. These payments are preferably based on LIBOR or some other appropriate rate. These interest payments may or may not be deferrable, depending upon the structure of the transaction and the nature of the financed assets.

In the preferred embodiment of the present invention, the market values of (1) the portfolio of assets 119 acquired by the CDO entity 105 and (2) the financed assets 157 are measured periodically. Depending upon the specific terms agreed upon by the lender 101 and the equity investor 103, decreases in the market values of either of these beyond an agreed-upon threshold would require the equity investor 103 to make additional payments 155 that either would be (1) set aside 163 as additional cash collateral or (2) paid 161 to the CDO entity 105 through the lender 101 in the form of an additional contribution of equity capitalization to the CDO entity 105. Alternatively, equity investor 103 may make such payment directly (not shown) to CDO entity 105. These additional payments 155 are referred to as “top up” payments. The equity investor also may be required to make additional “top-up” payments to provide the lender 101 with additional security against its future funding obligations. Top-up payments that are applied to increase the equity capitalization of the CDO entity 105 would have the effect of increasing the value of the lender's 101 collateral (represented by the CDO equity). Additional collateral provided in the form of top-up payments would compensate for any fluctuations in the value of the related financed assets 157 or the underlying assets 119 subject to the CDO.

The related financing arrangement 202 provided by lender 101 can be in the nature of any type of debt or equity financing arrangement that requires external collateralization particularly when such external collateralization is needed as a result of the risks associated with either the structure of such an arrangement or the associated collateral. The risk-reward profile of any of these financing arrangements potentially could be improved by the integration of a CDO structure 100 pursuant to the methodology of the present invention.

Examples of such financing arrangements are found frequently in the motion picture industry, especially in the area of gap financings or certain motion picture production co-financing arrangements, wherein the repayment of investments made to finance the production of a motion picture are not collateralized by assets with a readily ascertainable cash value (e.g., commitments from motion picture distributors to acquire the motion picture exploitation rights in exchange for an up-front payment). Of course, it is contemplated that any other type of financing which utilizes assets with a value that is subject to rapid change, or which does not have a readily ascertainable cash value, can be used in accordance with present invention.

Further, other types of specialty finance arrangements known in the art can be used in accordance with the present invention.

Example of a Related Financing—Motion Picture Co-Financing

Referring next to FIG. 2, depicted is an example of a financing arrangement 200 in the motion picture industry.

Under the financing structure described herein, any collateral securing the related financing arrangement 200 is delivered to lender 101 under the terms of the participation arrangement 100 as described below.

In accordance with the structure depicted in FIG. 2, equity investor 103 enters into a co-financing arrangement as shown by 203 with third party 201. In this example, it is assumed that third party 201 is a motion picture studio. Any co-financing arrangement known in the art can be utilized in accordance with the present invention. In this example, equity investor 103 agrees to fund a percentage of the budgeted costs associated with the production of a slate of several motion pictures. In return, third party 201 agrees to pay a percentage of the gross revenues received from the exploitation of the slate of motion pictures (less certain distribution fees, expenses, and other deductions) to equity investor 103. Equity investor 103 receives returns which are highly variable because they depend upon the performance of the pictures in the slate which cannot be determined in advance.

Accordingly, it would ordinarily be difficult for equity investor 103 to obtain committed financing from a third-party lender of all or a substantial portion of its obligations under such an arrangement unless equity investor 103 pledged collateral in addition to its rights in the slate of motion pictures.

Under the financing structure described herein, equity investor 103 assigns all of its rights in the slate of motion pictures to lender 101 as shown by 205. In addition, under the present invention, the lender 101 also has the benefit of the equity interest in the CDO Entity. 105 Therefore, in return, lender 101 agrees to provide third party 201 capital as shown by 207. In this example, it is assumed that the capital is used to fund the slate of motion pictures. However, the capital can be used for any purpose in accordance with present invention.

In this case, it is assumed that the rights assigned to lender 101 by equity investor 103 constitutes all property associated with related financing arrangement 200. As a result, lender 101 is able to rely on the cash flows received from CDO entity 105 and any cash flows generated by property associated with related financing arrangement 200 to reduce its risk exposure associated with the co-financing.

Advantageously, the use of the participation arrangement 100 allows for lower cost and non-recourse borrowing, necessary letter of credit “LC” (or “synthetic” LC) facilities for specialty financings and film-related deals (including “negative pick-ups” and co-finance deals), and investment of collateral account assets to make the most out of collateralized capital. In addition, double digit returns for collateral account equity can be achieved through the CDO structure of the present invention, and equity investments can be crossed in order to maximize collateral account equity financial strength.

Because, in the present invention, the benefits associated with the related co-financing arrangement 202 are passed back to equity investor 103 in the form of fixed payments via a synthetic contract, as depicted in 203, 205 and 207, and the benefits associated with the equity issued by the CDO entity 105 are passed back to the equity investor via the participation arrangement 100, in each case rather than being first acquired by the equity investor and then pledged to the lender, the lender 101 maintains its collateral free and clear of the bankruptcy estate (i.e., equity investor 103). As a result, the participation arrangement 100 obviates the need for a bankruptcy remote structure.

In addition, the participation arrangement 100 used in accordance with the present invention allows for debt advances at a high advance rate. The financing structure of the present invention also allows equity investor 103 to act with speed and certainty, a fundamental competitive advantage in both specialty financing and film-related deals. As a result, the participation arrangement 100 and the synthetic arrangement 202 are materially superior to other specialty financing arrangements.

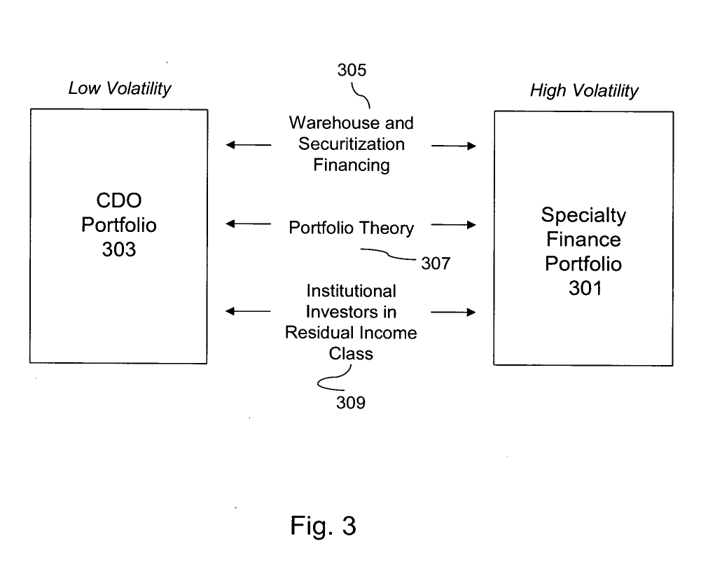

FIGS. 3-5 pictorially illustrate the resulting portfolio with an improved risk-reward profile. As depicted in FIG. 3, the asset classes of CDO portfolio assets 303 and specialty finance portfolio 301 have striking similarities when considered in the context of specialty finance and income strategies for institutional investors. By way of non-limiting examples, specialty finance portfolio 301 and CDO portfolio 303 are similarly structured in regards to warehouse and securitization financing 305 and principles of portfolio theory 307. In addition, CDO portfolio 303 and specialty finance portfolio 301 both utilize institutional investors in their respective residual income class as depicted by 309. Therefore, the two portfolios serve similar markets despite the large difference in relative volatility between the two portfolios. The large difference in volatility between the asset classes indicates that they are non-correlated. As a result, according to modern portfolio theory, a blended portfolio that utilizes similarly structured non-correlated portfolios results in a portfolio with improved risk-reward characteristics.

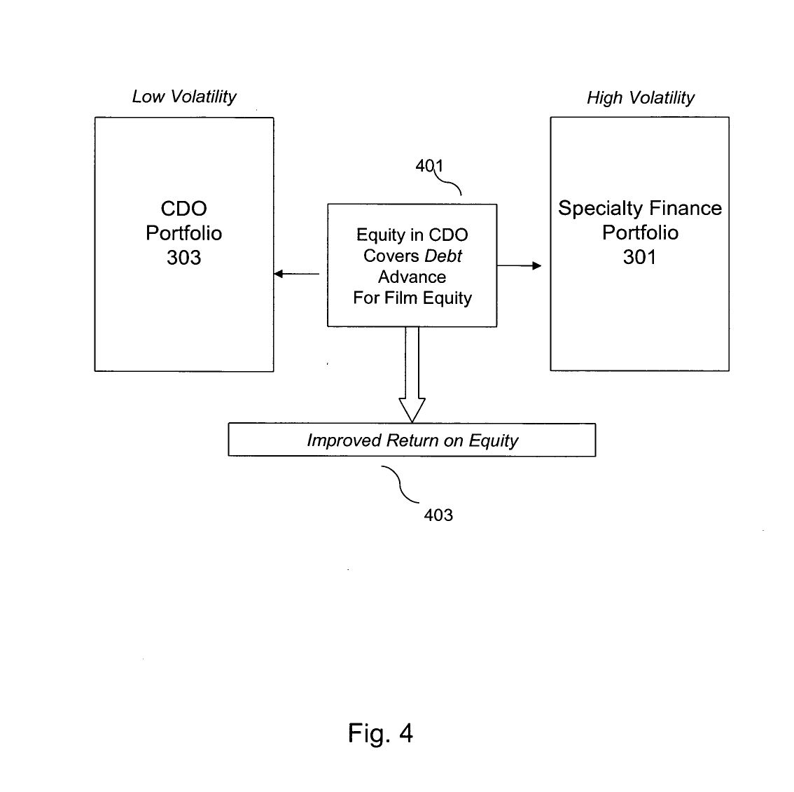

FIG. 4 depicts another benefit of the present invention. As shown, non-correlation of CDO portfolio 303 and specialty finance portfolio 301, coupled with the extremely low volatility of CDO portfolio 303, allows for the double use of equity between both portfolios as part of a structured financing. In short, the equity in CDO portfolio 303 not only offers a return to equity investor 103, but it helps pay as shown in 401 the debt advance of the property associated with specialty finance portfolio 301. By servicing the debt up front, proceeds derived from specialty finance portfolio 301 are immediately available as equity. Advantageously, this allows for an even higher return on equity for a blended portfolio as shown in 403.

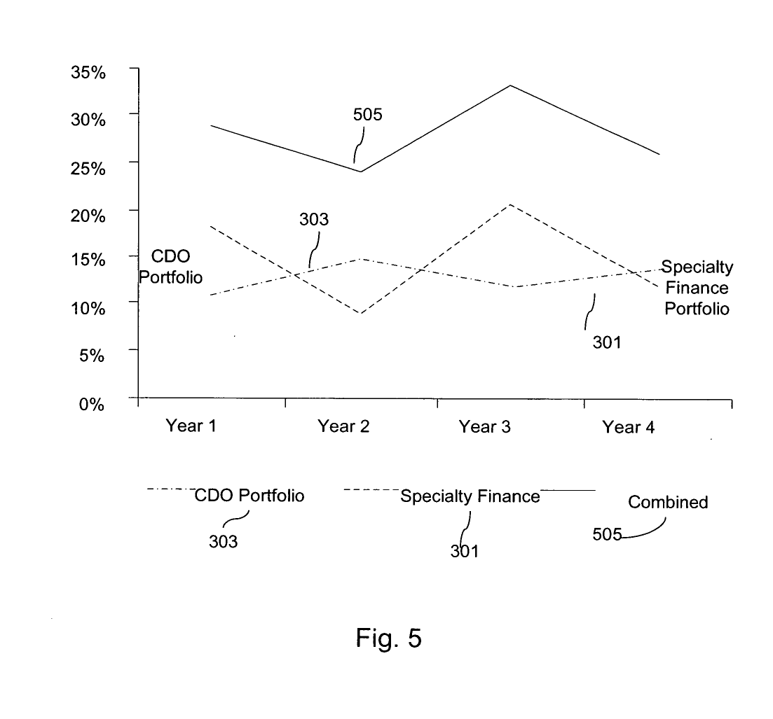

Referring now to FIG. 5, shown is graphical representation of the improved return on equity available for blended portfolio 505. As shown, volatility of specialty finance portfolio 301, such as a film slate, is offset by the relatively low volatility of CDO portfolio 303. As can be seen from FIG. 5, blended portfolio 505 comprising CDO portfolio 303 and specialty finance portfolio 301 reduces the volatility of specialty finance portfolio 301 and enhances returns on equity of CDO portfolio 303. As a result, blended portfolio 505 has an improved risk reward profile.

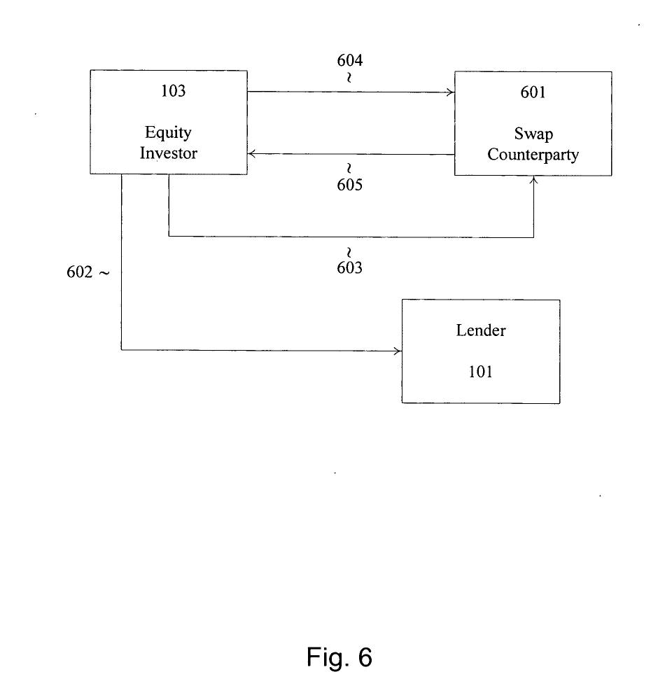

FIG. 6 depicts how a result similar to the foregoing can be achieved through the use of a total return swap and associated cash collateral in place of a pledge of the equity interest in a CDO entity. First, as depicted by 603, 604 and 605, the equity investor and a swap counterparty enter into a portfolio total return swap that references a portfolio of high-yield debt, loans or other assets that might be included in a CDO-type structure. Under the portfolio total return swap, at the time that the swap is entered into, the equity investor makes an up-front payment and/or posts cash collateral 603 in the nature of initial margin. From time to time thereafter, the equity investor makes additional payments relating to any losses on the portfolio. 605 In return, the swap counterparty passes through to the equity investor returns relating to the reference portfolio. 605

As depicted by 602, the equity investor pledges to the lender 101 the equity investor's interest in the total return swap and any associated cash collateral, along with the equity investor's interest in a portfolio of high-risk financed assets 175, such as motion picture assets. Thus, any cash collateral is pledged to both the lender and the swap counterparty, thereby allowing the equity investor to “double-use” the cash collateral to produce returns associated with both the portfolio total return swap and the high-risk financed assets. In return, the lender makes loans to finance the acquisition cost of the high-risk financed assets. The lender 101 is comfortable with the arrangement because the lender 101 receives a security interest in the equity investor's 103 interest in the portfolio total return swap, together with its interest in the related cash collateral, as additional security. Thus, the lender 101 is not merely dependent for repayment upon the performance of the high-risk financed assets 175 but has the benefit of cash collateral and an interest in a total return swap. Note that the pledge of the cash collateral and the interest in the portfolio total return swap is economically equivalent to a pledge of the equity interest in a CDO Entity.

What is claimed is:

1. A method of financing assets comprising:
entering into a CDO-type structure between a first party and an investor, said CDO-type structure associated with a first asset portfolio;
entering into a second financing arrangement between a lender and said investor, said financing arrangement associated with at least one financed asset; and
utilizing said CDO-type structure to collateralize said financing arrangement.

2. The method of claim 1 wherein said CDO-type structure comprises a CDO.

3. The method of claim 1 wherein said CDO-type structure comprises a cash CDO.

4. The method of claim 1 wherein said CDO-type structure comprises a synthetic CDO.

5. The method of claim 1 wherein said CDO-type structure comprises a market value CDO.

6. The method of claim 1 wherein said CDO-type structure comprises a cashflow CDO.

7. The method of claim 1 wherein said CDO-type structure comprises a market value cash CDO.

8. The method of claim 1 wherein said CDO-type structure comprises a market value synthetic CDO.

9. The method of claim 1 wherein said CDO-type structure comprises a cashflow cash CDO.

10. The method of claim 1 wherein said CDO-type structure comprises a cashflow synthetic CDO.

11. The method of claim 1 wherein said CDO-type structure comprises a portfolio credit derivative.

12. The method of claim 1 wherein said CDO-type structure comprises a portfolio credit derivative that substantially replicates the economics of a CDO.

13. The method of claim 11 wherein said portfolio credit derivative comprises a portfolio total return swap.

14. The method of claim 13 wherein said portfolio total return swap is a market value portfolio total swap.

15. The method of claim 13 wherein said portfolio total return swap is a cashflow portfolio total return swap.

16. The method of claim 1, wherein said CDO-type structure further comprises top-up payments.

17. The method of claim 1, wherein said CDO-type structure comprises a notional amount.

18. The method of claim 1, wherein said CDO-type structure comprises a floating amount payment.

19. The method of claim 1, wherein said CDO-type structure comprises a fixed payment amount.

20. The method of claim 19, wherein said fixed payment amount comprises distributions related to said CDO-type structure and distributions related to said financial asset.

21. The method of claim 1 wherein said first asset portfolio is selected such that risk associated with said first asset portfolio is selected such that it is not highly positively correlated to said at least one financial asset.

22. The method of claim 2 wherein said CDO is collateralized loan obligation.

23. The method of claim 2 wherein said CDO is a collateralized bond obligation.

24. The method of claim 1 wherein said at least one financial asset comprises at least one motion picture.

25. The method of claim 24 wherein said first asset portfolio comprises a portfolio of bonds.

26. The method of claim 1 wherein said first party is a lender, said method further comprises:
a CDO entity which will issue equity in exchange for a purchase price;
said lender and said investor entering into a participation arrangement, said participation arrangement requiring said investor to make an initial up-front payment to lender in the amount of said purchase price;
said lender acquiring said equity;
said CDO entity acquiring a diversified asset portfolio of bonds and/or loans;
said lender financing the acquisition of said at least one financial asset; and
said investor compensating lender for interest on said lender financing.

27. The method of claim 26 wherein said investor compensation to said lender is deferrable.

28. The method of claim 26 wherein said lender financing is made as an advance payable to said investor.

29. The method of claim 26 wherein said lender financing is made as an advance to one or more third parties on behalf of said investor.

30. The method of claim 26 wherein said at least one financial asset comprises a pool of motion pictures.

31. A method of improving the risk-return portfolio of a collateralized loan obligation portfolio comprising:
entering into a CDO-type structure between a first party and an investor, said CDO-type structure associated with a first asset portfolio having a first volatility;
entering into a second financing arrangement between a lender and said investor, said financing arrangement associated with at least one financed asset having a second volatility wherein said second volatility is substantially greater than said first volatility; and
utilizing said CDO-type structure to collateralize said financing arrangement thereby forming a blended asset portfolio comprising said first asset portfolio having a first volatility and said at least one financed asset having said second volatility.

32. The method of claim 31, wherein said at least one financed asset comprising at least one motion picture.

33. The method of claim 1 wherein said CDO-type structure comprises;
a total return swap entered into between said first party and said investor, said total return swap said first asset portfolio.

34. The method of claim 33 wherein said investor further makes an initial payment comprising an initial margin.

35. The method of claim 34 wherein said investor makes additional payments relating to any loss in said first asset portfolio.

36. The method of claim 33 wherein said investor further posts a cash collateral.

37. The method of claim 36 wherein said investor pledges said investor's interest in (a) said total return swap (b) said at least one financed asset, and (c) said collateral to said lender.

38. A method of servicing a financial structure between a lender and an investor, said method comprising:
calculating distributions received by a CDO entity on equity issued by said CDO entity, said CDO entity being associated with a first asset portfolio, the CDO-type structure being used to collateralize at least one financed asset in a financing arrangement, said lender being a party to the financing arrangement;
determining amounts received by said lender with respect to said financing arrangement; and
calculating a payment to said investor as a function of said calculated distributions and said determined amounts.

39. The method of claim 38 further comprising:
said lender paying said calculated payments to said investor on a net basis against top-up amounts that may be payable by said investor to said lender

40. A method of servicing a financial structure between a lender and an investor, said investor having acquired a CDO entity and pledged said CDO entity to said lender, said method comprising:
calculating distributions received by a CDO entity on equity issued by said CDO entity, said CDO entity being associated with a first asset portfolio, the CDO-type structure being used to collateralize at least one financed asset in a financing arrangement, said lender and investor being a party to the financing arrangement under which said investor must satisfy certain obligations;
determining amounts received by said lender with respect to said related financing arrangement;
said investor receiving said distributions unless there is a default by said investor on said financing arrangement; and
if there is a default by said investor on said financing arrangement said lender foreclosing on said CDO entity and applying said proceeds to repay said investors obligations.
